(19) United States
(12) Patent Application Publication
(10) Pub. No.: US 2021/0099967 A1
(43) Pub. Date: Apr. 1, 2021

(54) TRANSCEIVER TIMING CONTROLS

(71) Applicant: QUALCOMM Incorporated, San Diego, CA (US)

(72) Inventors: Hee Choul LEE, Santa Clara, CA (US); Anilkumar KANERIYA, Fremont, CA (US); Minkui LIU, San Diego, CA (US); Bok Tae SIM, San Ramon, CA (US)

(21) Appl. No.: 16/590,022

(22) Filed: Oct. 1, 2019

(51) Int. Cl. H04W 56/00; H04B 7/26; H04B 7/08; H04B 7/212; H04J 3/06

(52) U.S. Cl. CPC H04W 56/0045; H04W 56/0085; H04J 3/0682; H04B 7/082; H04B 7/2125; H04B 7/2643

(57) ABSTRACT

Certain aspects of the present disclosure provide techniques for transceiver timing controls in a synchronized network. A method that may be performed by a user equipment (UE) or a base station (BS) includes determining a first instance of time corresponding to a beginning of a wireless transmission of data by a transceiver, determining a second instance of time corresponding to a beginning of a process configured to load a plurality of buffers with a portion of the data, loading of the plurality of buffers with the data, and transmitting, the data at the first instance of time.

### BACKGROUND

### Field of the Disclosure

Aspects of the present disclosure relate to wireless communications, and more particularly, to techniques for transceiver timing controls.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved ability to transmit wireless within shortened allocated time resources.

Certain aspects provide a method for wireless communication. The method generally includes determining, by a baseband processor, a first instance of time corresponding to a beginning of a wireless transmission of data by a transceiver, wherein the baseband processor is coupled to the transceiver via a physical connection. The method also includes, determining, by the baseband processor, a second instance of time corresponding to a beginning of a process configured to load a plurality of buffers with a portion of the data, wherein the second instance of time is determined as a function of an amount of time required to complete the process and the first instance of time. The method also includes, loading, by the transceiver, of the plurality of buffers with the data, wherein the transceiver initiates the loading at the second instance of time. The method also includes, transmitting, by the transceiver, the data at the first instance of time.

Certain aspects provide for an apparatus configured for wireless communication. In some examples, the apparatus includes a memory and a baseband processor communicatively coupled to the memory. In some examples, the baseband processor is configured to determine a first instance of time corresponding to a beginning of a wireless transmission of data, determine a second instance of time corresponding to a beginning of a process configured to load a plurality of buffers with a portion of the data, wherein the second instance of time is determined as a function of an amount of time required to complete the process and the first instance of time. In some example, the apparatus includes a transceiver communicatively coupled to the baseband processor via a physical connection, wherein the transceiver is configured to load the plurality of buffers with the data, wherein the transceiver initiates the loading at the second instance of time, and transmit the data at the first instance of time.

Certain aspects provide for a non-transitory computer readable medium having instructions stored thereon for determining, by a baseband processor, a first instance of time corresponding to a beginning of a wireless transmission of data by a transceiver, wherein the baseband processor is coupled to the transceiver via a physical connection, determining, by the baseband processor, a second instance of time corresponding to a beginning of a process configured to load a plurality of buffers with a portion of the data, wherein the second instance of time is determined as a function of an amount of time required to complete the process and the first instance of time, loading, by the transceiver, of the plurality of buffers with the data, wherein the transceiver initiates the loading at the second instance of time, and transmitting, by the transceiver, the data at the first instance of time.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an expanded view of an exemplary NR radio frame format, in accordance with certain aspects of the present disclosure.

FIG. 3 is a diagram illustrating a first resource block (RB) having a nominal numerology, and a second RB having a scaled numerology, in accordance with certain aspects of the present disclosure.

FIG. 4 is a block diagram illustrating an example hardware implementation of a baseband processor and wireless transceiver, in accordance with certain aspects of the present disclosure.

FIG. 5 is a timeline illustrating separate instances of time, and durations of time for loading a register or buffer with wireless data and for transmitting the data, in accordance with certain aspects of the present disclosure.

FIG. 6 is a flow diagram illustrating example operations for wireless communication, in accordance with aspects of the present disclosure.

FIG. 7 is a block diagram illustrating a communications device that may include various components configured to perform operations for the techniques disclosed herein in accordance with aspects of the present disclosure.

FIG. 8 is a block diagram conceptually illustrating a design of an example base station (BS) and user equipment (UE), in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for using a slave device (e.g., transceiver) to write to a register on a master device (e.g., broadband processor). For example, certain aspects provide techniques for transceiver timing control.

Wireless communication requires rapid availability of data to a transceiver to meet latency, reliability, and priority requirements associated with the data. In some examples, a baseband processor will store data for transmission in a local memory of the baseband processor and communicate the data to the transceiver once the time for transmitting the data is reached. The transceiver will transmit the data over the duration of the time resources allocated to it.

However, in some cases, such as in fifth generation (5G) wireless communication, scalable numerology allows time resources for transmitting data to be scaled, in some cases resulting in relatively narrow, or shortened durations of time for transmitting the data. In some cases, the shortened duration of time can create issues because the time required for the baseband processor to communicate the data from the local memory to the transceiver can cut into the shortened duration of time and prevent the transceiver from using the entire duration of the time resources for transmitting the data. In other words, the time required for communicating data between hardware elements within a device (e.g., UE) can reduce an already shortened duration for data transmission by the device to another device (e.g., BS). Accordingly, techniques for aligning data readiness with transmission timing are desirable so that the entire duration of relatively narrow time resources can be used for data transmission.

The following description provides examples of preparing data for transmission in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

New Radio (NR) is an emerging wireless communications technology under development in conjunction with the 5G Technology Forum (5GTF). NR access (e.g., 5G NR) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

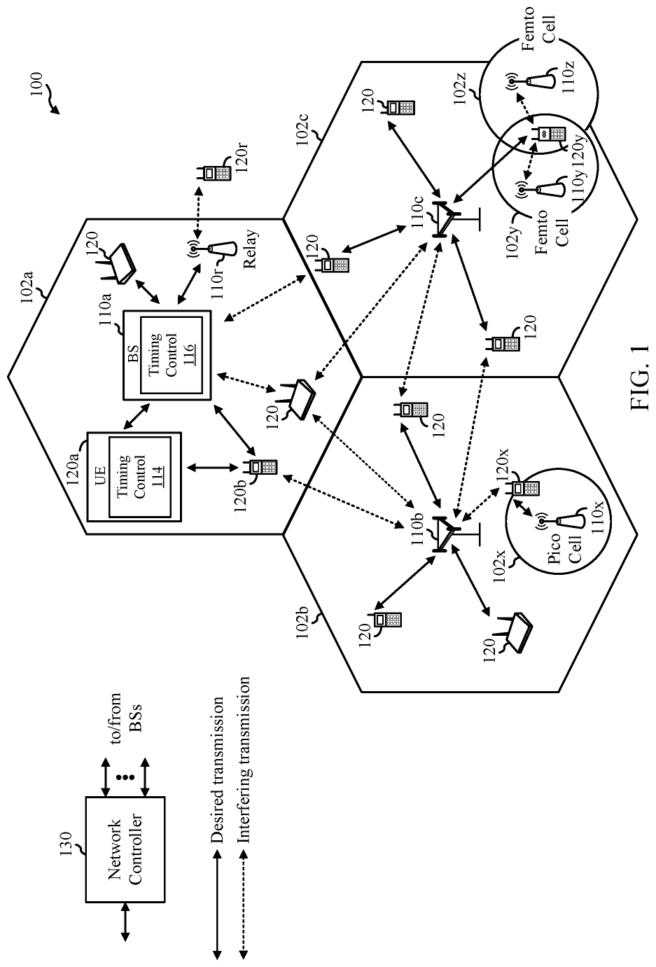

FIG. 1 illustrates an example wireless communication network 100 in which aspects of the present disclosure may be performed. For example, the wireless communication network 100 may be an NR system (e.g., a 5G NR network). According to certain aspects, the base stations (BSs) 110 and user equipment (UEs) 120 may be configured for preparing data for rapid availability for transmission.

As shown in FIG. 1, the BS 110a includes a timing control module 116. The timing control module 116 may be configured to determine timing associated with transmission of wireless data (e.g., a transmission start time corresponding to an allocated time resource for transmission of the wireless data) to another device such as a UE 120, as well as timing associated with an amount of time required to communicate the wireless data through various hardware components of the BS 110a until the wireless data reaches the transceiver of the BS 110a. In certain aspects, the timing control module 116 may load a plurality of buffers of the BS 110a with the data, wherein the loading is initiated at a time determined as a function of the transmission start time for transmitting to the other device and the amount of time required to communicate the wireless data through various hardware components of the BS 110a. In the case of the BS 110a, the timing control module 116 may be configured for preparing data for rapid availability for transmission in a wireless transmission to a UE (e.g., UE 120a) or in a transmission to a relay station 110r.

As shown in FIG. 1, the UE 120a includes a timing control module 114 similar to the timing control module 116 of BS 110a. In the case of the UE 120a, the timing control module 114 may be configured for preparing data for rapid availability for transmission in a sidelink transmission to another UE (e.g., UE 120b) or in a transmission to a BS 110a.

As illustrated in FIG. 1, the wireless communication network 100 may include a number of base stations (BSs) 110 and other network entities. ABS may be a station that communicates with user equipment (UE). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. In some examples, a cell may not necessarily be stationary, and the geographic area of the cell may move according to the location of a mobile BS. In some examples, the BSs may be interconnected to one another and/or to one or more other BSs or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS 110 may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). ABS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize OFDM on the downlink and SC-FDM on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

NR may utilize OFDM with a CP on the uplink and downlink and include support for half-duplex operation using TDD. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

In FIG. 1, a solid line with double arrows indicates desired transmissions between a UE and a serving BS, which is a BS designated to serve the UE on the downlink and/or uplink. A finely dashed line with double arrows indicates potentially interfering transmissions between a UE and a BS.

In a further aspect of the wireless communication network 100, sidelink signals may be used between UEs 120 without necessarily relying on scheduling or control information from a BS 110. For example, two or more UEs (e.g., UE 120a and 120b) may communicate with each other using peer to peer (P2P) or sidelink signals without relaying that communication through BS 110. In another example, a UE 120 may function as a scheduling entity in a device-to-device (D2D), peer-to-peer (P2P), or vehicle-to-everything (V2X) network, and/or in a mesh network. In a mesh network example, UEs 120a and 120b may optionally communicate directly with one another in addition to communicating with the BS 110a. Thus, in a wireless communication system with scheduled access to time—frequency resources and having a cellular configuration, a P2P configuration, or a mesh configuration, a BS 110 and one or more UEs 120 may communicate utilizing the scheduled resources.

Transmissions over the air interface from a BS 110 to one or more UEs 120, or between a first UE (e.g., UE 120a) and a second UE (e.g., UE 120b) may be referred to as downlink transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE 120 to a BS 110 may be referred to as uplink transmissions. In accordance with further aspects of the present disclosure, the term uplink may refer to a point-to-point transmission originating at a UE 120 (e.g., sidelink and V2X communications).

In some examples, access to the air interface may be scheduled, wherein a scheduling entity (e.g., a base station 110) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UE 120). That is, for scheduled communication, the UE 120 may utilize resources allocated by the scheduling entity.

The air interface in the wireless communication network 100 may utilize one or more multiplexing and multiple access algorithms to enable simultaneous communication between the various devices. For example, 5G NR specifications provide multiple access for uplink transmissions from UEs 120a and 120b to base station 110a, and for multiplexing for downlink transmissions from base station 110a to one or more UEs 120a and 120b, utilizing OFDM with a CP. In addition, for uplink transmissions, 5G NR specifications provide support for discrete Fourier transform-spread-OFDM (DFT-s-OFDM) with a CP (also referred to as SC-FDMA). However, within the scope of the present disclosure, multiplexing and multiple access are not limited to the above schemes, and may be provided utilizing TDMA, CDMA, FDMA, sparse code multiple access (SCMA), resource spread multiple access (RSMA), or other suitable multiple access schemes. Further, multiplexing downlink transmissions from the base station 110 to UEs 120 may be provided utilizing time division multiplexing (TDM), code division multiplexing (CDM), frequency division multiplexing (FDM), OFDM, sparse code multiplexing (SCM), or other suitable multiplexing schemes.

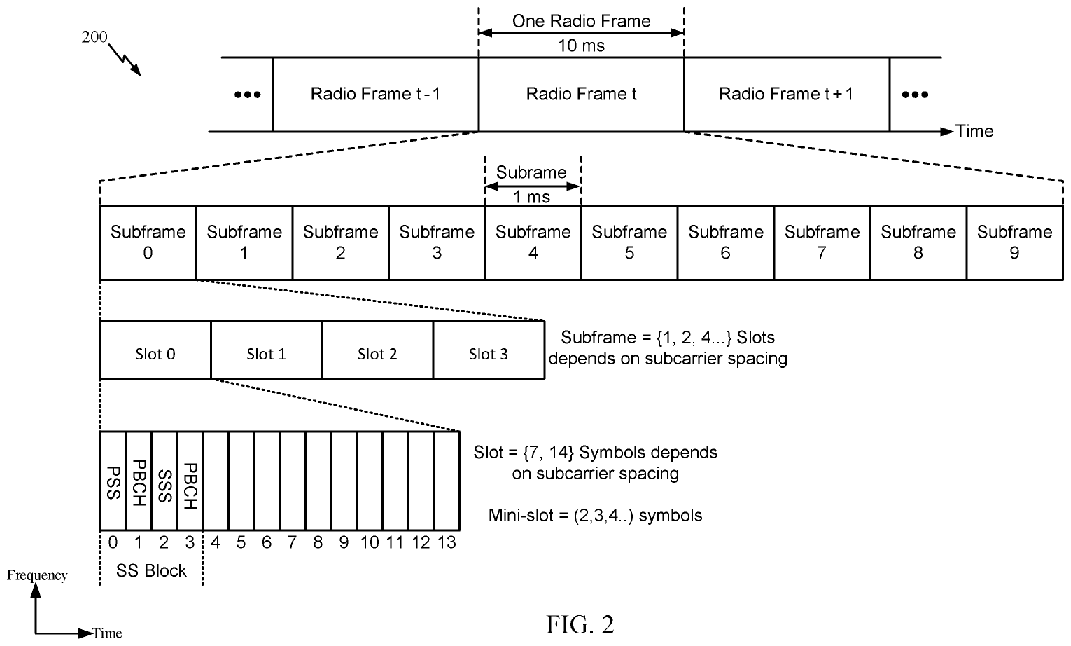

Referring now to FIG. 2, an expanded view of an exemplary NR radio frame format 200 is illustrated. It should be understood by those of ordinary skill in the art that the various aspects of the present disclosure may be applied to a DFT-s-OFDMA waveform or a CP-OFDM waveform in substantially the same way as described herein. That is, while some examples of the present disclosure may focus on an OFDM link for clarity, it should be understood that the same principles may be applied as well to DFT-s-OFDMA and CP-OFDM waveforms.

The transmission timeline for each of the downlink and uplink may be partitioned into units of radio frames. Here, time is in the horizontal direction with units of OFDM symbols; and frequency is in the vertical direction with units of subcarriers or tones. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot is a sub-slot structure (e.g., 2, 3, or 4 symbols).

Each symbol in a slot may indicate a link direction (e.g., downlink, uplink, or flexible) for data transmission and the link direction for each subframe may be dynamically switched. The link directions may be based on the slot format. Each slot may include downlink/uplink data as well as downlink/uplink control information.

In NR, a synchronization signal (SS) block is transmitted. The SS block includes a PSS, a SSS, and a two symbol PBCH. The SS block can be transmitted in a fixed slot location, such as the symbols 0-3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes.

Each symbol in a slot may indicate a link direction (e.g., downlink, uplink, or flexible) for data transmission and the link direction for each subframe may be dynamically switched. The link directions may be based on the slot format. Each slot may include downlink/uplink data as well as downlink/uplink control information.

In OFDM, to maintain orthogonality of the subcarriers or tones, the subcarrier spacing may be equal to the inverse of the symbol period. A numerology of an OFDM waveform refers to its particular subcarrier spacing and cyclic prefix (CP) overhead. A scalable numerology refers to the capability of the network to select different subcarrier spacing, and accordingly, with each spacing, to select the corresponding symbol duration, including the CP length. With a scalable numerology, a nominal subcarrier spacing (SCS) may be scaled upward or downward by integer multiples. In this manner, regardless of CP overhead and the selected SCS, symbol boundaries may be aligned at certain common multiples of symbols (e.g., aligned at the boundaries of each 1 ms subframe). The range of SCS may include any suitable SCS. For example, a scalable numerology may support a SCS ranging from 15 kHz to 480 kHz.

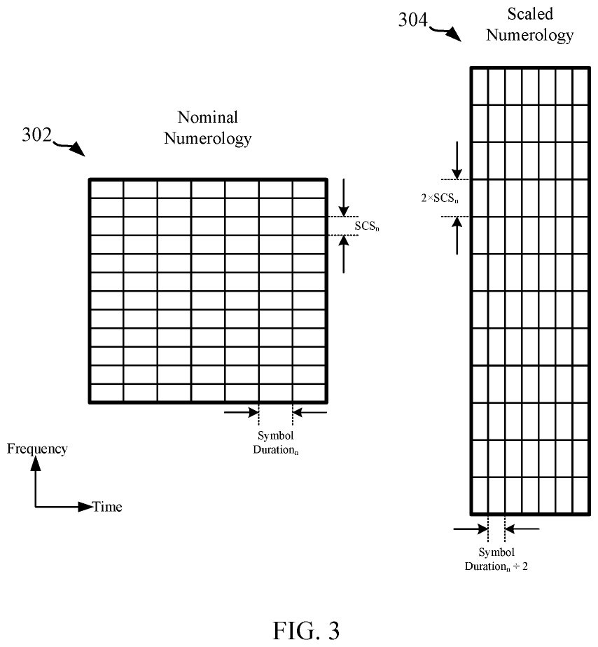

To illustrate this concept of a scalable numerology, FIG. 3 shows a first resource block (RB) 302 having a nominal numerology, and a second RB 304 having a scaled numerology. Generally, an RB relates to a block of REs that contain any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that an RB corresponds to a single direction of communication (either transmission or reception for a given device).

As one example, the first RB 302 may have a ‘nominal’ subcarrier spacing (SCSn) of 30 kHz, and a ‘nominal’ symbol duration of 333 μs. Here, in the second RB 304, the scaled numerology includes a scaled SCS of double the nominal SCS, or 2×SCSn=60 kHz. Because this provides twice the bandwidth per symbol, it results in a shortened symbol duration to carry the same information. Thus, in the second RB 304, the scaled numerology includes a scaled symbol duration of half the nominal symbol duration, or (symbol duration)÷2=167 μs.

As mentioned above, in certain systems, (e.g., 5G NR systems) the symbol duration for carrying information can be shortened. However, ensuring that data is ready for transmission during a shortened transmission duration may present issues. For example, transceiver hardware, and any master hardware that controls the transceiver hardware can introduce delays associated with, for example, retrieving data from a digital storage device, passing the data through multiple hardware components, etc. That is, transceiver hardware, and any master hardware that controls the transceiver hardware may delay the data and prevent an alignment between a time the data is ready for transmission and time the transmission is scheduled to start.

Accordingly, techniques for aligning data readiness with transmission timing are desirable.

### Example Hardware for Transceiver Timing Controls

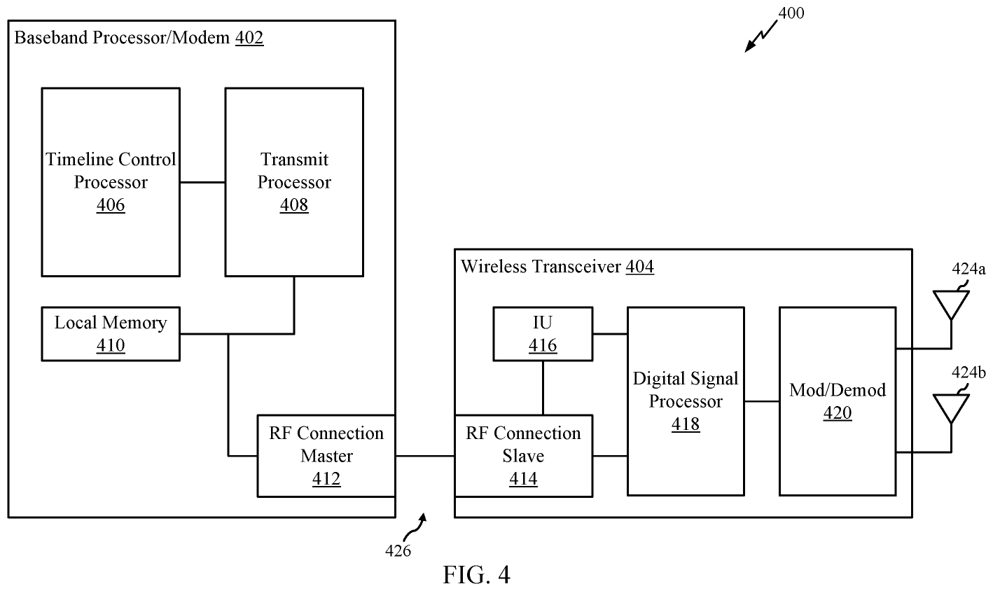

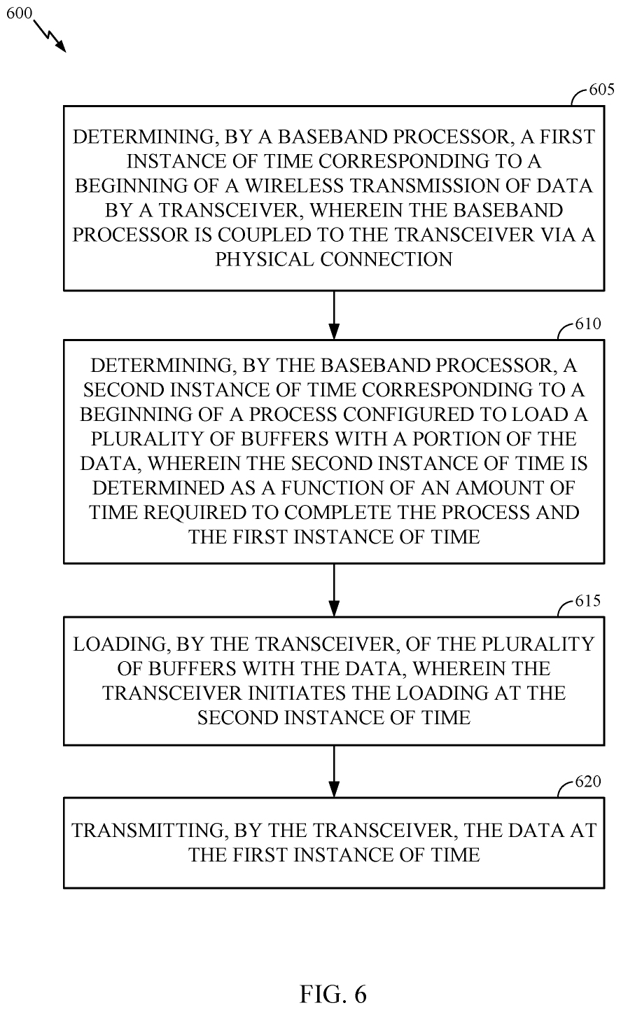

FIG. 4 is a block diagram illustrating an example hardware implementation 400 of a baseband processor 402 and wireless transceiver 404. In accordance with various aspects of the disclosure, an element, or any portion of an element, or any combination of elements may be implemented with a processing system that includes one or more processors. For example, the baseband processor 402 and the wireless transceiver 404 may include one or more processors configured to execute the operations described below and illustrated in FIG. 6.

In certain aspects of the disclosure, the baseband processor 402 may include a timeline control processor 406 communicatively coupled to a transmit processor 408, a local memory 410, and an RF connection master 412. In certain aspects, the timeline control processor 406 is configured for various functions, including, for example, determining a first instance of time corresponding to a beginning of a wireless transmission of data by the transceiver 404, and determining a second instance of time corresponding to a beginning of a process configured to load a plurality of buffers with a portion of the data, wherein the second instance of time is determined as a function of an amount of time required to complete the process and the first instance of time.

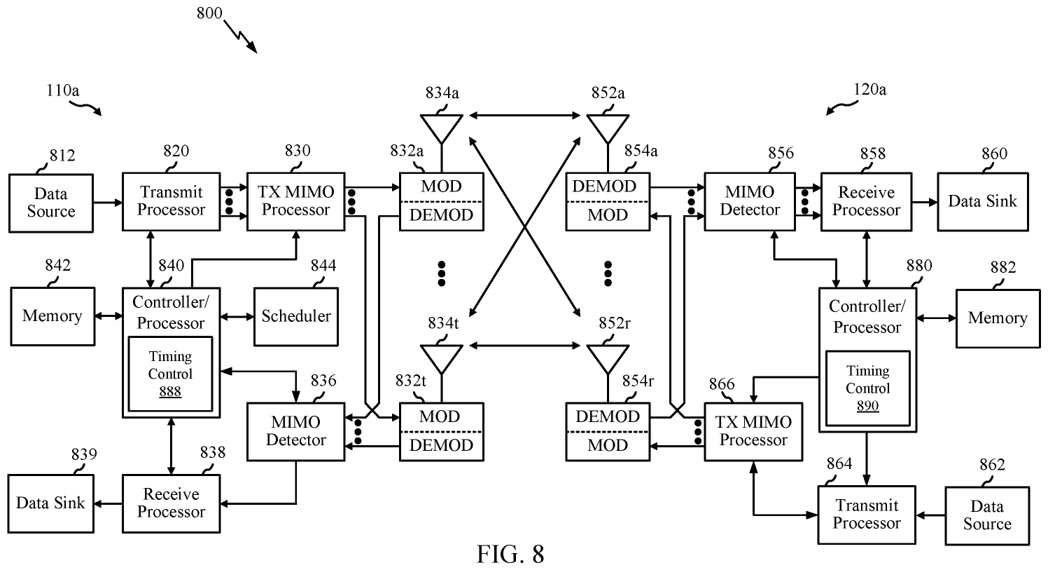

In certain aspects, the transmit processor 408 is configured to generate and/or receive wireless data for transmission by the transceiver 404, and send the data to the local memory 410 for storage. For example, the transmit processor 408 may be a data source 812/862 as described and illustrated in FIG. 8 below.

The local memory 410 may include, by way of example, a non-volatile memory (NVM), such as a solid state drive (SSD) 134 made up of one or more one or more dies or planes of flash memory cells, or any other suitable medium for storing digital data that may be accessed and read by a computer. In some examples, the local memory 410 may include a volatile memory (e.g., random access memory RAM, dynamic RAM, static RAM, etc.). In some examples, the local memory 410 may reside internal to the baseband processor 402 (e.g., on the same die), external to the baseband processor 402, or distributed across multiple entities including the baseband processor 402. Those skilled in the art will recognize how best to implement the described functionality presented throughout this disclosure depending on the particular application and the overall design constraints imposed on the overall system.

As shown in FIG. 4, communications between the baseband processor 402 and the transceiver 404 are facilitated by a physical radio frequency (RF) connection 426. Communications between baseband processor 402 and the transceiver 404 may operate under a communication protocol, such as a DigRF interface standard or a PCIe serial communication protocol or other suitable communication protocols such as, ethernet, serial attached SCSI (SAS), serial AT attachment (SATA), and other suitable serial communication protocols.

In some examples, the RF connection 426 provides for high-speed, bi-directional communication between the baseband processor 402 and the transceiver 404. For example, the RF connection 426 may include multiple communication channels (or “lanes”) that can be aggregated for communication of data via multiplexing data over the channels. For example, each channel individually may be characterized by a 480 megabytes per second transmission rate. In this example, the RF connection 426 can multiplex data for communication over both a first channel and a second channel to permit a data transfer rate of at least 960 megabytes a second.

The RF connection 426 includes an RF connection master 412 of the baseband processor and an RF connection slave 414 of the transceiver 404. The RF connection master 412 and the RF connection slave 414 provide physical interface components for communicating data to the transceiver 404. In some examples, the components include a buffer memory or register memory for temporary storage of data to be communicated to, or received by, the transceiver 404.

In certain aspects of the disclosure, the transceiver 404 includes the RF connection slave 414 coupled to an integer unit (IU) 416 and a digital signal processor (DSP) 418. The DSP is coupled to a modulator/demodulator 420 configured to receive and transmit wireless data via antennas 424a-424b. In certain aspects, the DSP 418 includes a buffer or memory cache configured to temporarily store data to be transmitted, or received, by the transceiver 404.

### Example Process for Transceiver Timing Controls

In certain aspects, the transceiver 404 wirelessly receives scheduling information from another wireless device (e.g., a BS 110a, UE 120a/120b) via a communication (e.g., a downlink, an uplink, or a sidelink, etc.) indicative of a time resource allocation for transmitting wireless data. The transceiver 404 may communicate the scheduling information to the baseband processor 402, which determines a first instance of time based on the time resource allocation. For example, the timeline control processor 406 may determine the first instance of time corresponding to the start of a wireless transmission of data by the transceiver 404 according to the time resource allocation.

In certain aspects, the timeline control processor 406 may also retrieve, from the local memory 410, information indicative of an amount of time required to complete a process configured to load a plurality of buffers with a portion of the data to be transmitted using the tie resource allocation. The information indicative of the amount of time required to complete the process may be pre-determined and stored on the local memory 410 during a step in manufacturing, or may be determined and stored during operation. For example, the amount of time may include the time required to retrieve the data to be transmitted from the local memory 410, and load: (i) a buffer of the RF connection master 412, (ii) another buffer of the RF connection slave 414, and (ii) another buffer of the DSP 418, with a portion of the data to be transmitted. Accordingly, the process is configured to pre-load buffers of certain hardware components with wireless data along a path to the antennas which will transmit the data.

In certain aspects, the timeline control processor 406 may determine a second instance of time, wherein the second instance of time is determined as a function of the amount of time required to complete the process and the first instance of time.

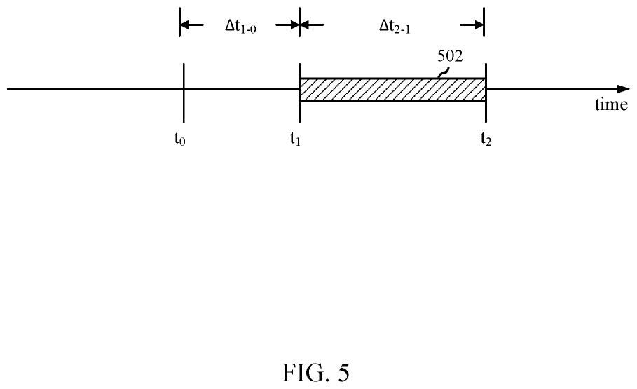

For example, as illustrated in FIG. 5, the first instance of time is shown as t₁, which relates to the beginning of a wireless transmission according to the time resource allocation. In this example, Δt₂₋₁, or the period of time between t₁ and t₂, is the duration of the time resources allocated for transmission of the wireless data 502, where the transmission is scheduled to end at t₂. In this example, the second instance of time is shown as t₀, which corresponds to a beginning of a process configured to load the plurality of buffers (e.g., buffers of the RF connection master 412, RF connection slave 414, and DSP 418) with the wireless data to be transmitted during the time resources allocated for its transmission. In this example, Δt₁₋₀, or the period of time between t₀ and t₁ is the amount of time required to complete the process. Accordingly, t₀ precedes t₁ in time, and t₁ precedes t₂ in time. It should be noted that the second instance of time (t₀) is determined by the timeline control processor 406 such that the process is completed prior to the first instance of time (t₁).

In certain aspects, the transmit processor 408 will load the local memory 410 with wireless data that will be transmitted during the time resources allocated for its transmission. Upon determination of the second instance of time, the baseband processor 402 may communicate the second instance of time to the transceiver 404 via the RF connection 426. In one example, the baseband processor 402 communicates information indicative of the second instance of time to the DSP 418. The DSP 418 may then communicate the information to the IU 416, which will initiate loading the plurality of buffers with the data at the second instance of time. In some examples, such functionality of loading of the IU 416 and/or transmit processor 408 may instead be implemented by a control logic of a state machine which is operable to load the local memory 410 with wireless data that will be transmitted during the time resources allocated for its transmission, and/or initiate loading the plurality of buffers with the data at the second instance of time. In some examples, a DSP instead of IU 416 and/or transmit processor 408 may initiate loading the plurality of buffers with the data at the second instance of time.

For example, at the second instance of time, the IU 416 may initiate loading the plurality of buffers by pulling a portion of the wireless data from the local memory 410 and pre-loading the plurality of buffers at the RF connection master 412, the RF connection slave 414, and the DSP 418. In certain aspects, communication relationship between the baseband processor 402 and the transceiver 404 is master/slave. For example, the baseband processor 402 is a master to the transceiver 404. In such an example, the IU 416 is configured to write the portion of the wireless data to the buffers of the RF connection master 412, the RF connection slave 414, and the DSP 418. The time required to write this information (e.g., Δt₁₋₀) is known by the baseband processor 402.

Accordingly, by the first instance of time (t₁), the plurality of buffers are pre-loaded with a portion of the wireless data, and transmission of the wireless data 502 can begin without any delay caused by loading a buffer or sending data between hardware components.

FIG. 6 is a flow diagram illustrating example operations 600 for wireless communication, in accordance with certain aspects of the present disclosure. The operations 600 may be performed, for example, by a BS (e.g., such as the BS 110a in the wireless communication network 100) or a UE (e.g., such as the UE 120a in the wireless communication network 100). Operations 600 may be implemented as software components that are executed and run on one or more processors (e.g., controller/processor 840/880 of FIG. 8). Further, the transmission and reception of signals by the BS in operations 600 may be enabled, for example, by one or more antennas (e.g., antennas 834/852 of FIG. 8). In certain aspects, the transmission and/or reception of signals by the BS may be implemented via a bus interface of one or more processors (e.g., controller/processor 840/880) obtaining and/or outputting signals.

The operations 600 may begin, at block 605, by determining, by a baseband processor, a first instance of time corresponding to a beginning of a wireless transmission of data by a transceiver, wherein the baseband processor is coupled to the transceiver via a physical connection.

At block 610, the operations 600 proceed by determining, by the baseband processor, a second instance of time corresponding to a beginning of a process configured to load a plurality of buffers with a portion of the data, wherein the second instance of time is determined as a function of an amount of time required to complete the process and the first instance of time.

At block 615, the operations 600 proceed by loading, by the transceiver, of the plurality of buffers with the data, wherein the transceiver initiates the loading at the second instance of time.

At block 620, the operations 600 proceed by transmitting, by the transceiver, the data at the first instance of time.

In certain aspects, the second instance of time is determined such that the process is completed prior to the first instance of time.

In certain aspects, the physical connection is a digital radio frequency (RF) connection (e.g., a DigRF interface).

In certain aspects, the plurality of buffers include at least a first register at a digital RF connection master of the baseband processor, a second register at an RF connection slave of the transceiver, and a third register at a digital signal processor (DSP) of the transceiver.

In certain aspects, the transceiver is a slave to the baseband processor, wherein the baseband processor comprises a control processor configured to perform the determining of the first instance of time and the second instance of time. In certain aspects, the operations 600 include wirelessly receiving, by the transceiver, information indicative of a time resource allocation for transmitting the data, communicating the information indicative of the time resource allocation to the control processor, and determining, by the control processor, the first instance of time based on the time resource allocation. In certain aspects, the operations 600 also include retrieving, by the control processor, the amount of time required to complete the process from a memory.

In certain aspects, the operations 600 also include signaling, by the baseband processor, the second instance of time to the transceiver. In certain aspects, signaling the second instance of time to the transceiver includes signaling, by the baseband processor, the second instance of time to a digital signal processor (DSP) of the transceiver, and signaling, by the DSP, the second instance of time to an integer unit of the transceiver, wherein the IU initiates loading the plurality of buffers with the data at the second instance of time. In some examples, such functionality of loading of the IU and/or transmit processor may instead be implemented by a control logic of a state machine which is operable to load the local memory with wireless data that will be transmitted during the time resources allocated for its transmission, and/or initiate loading the plurality of buffers with the data at the second instance of time. In some examples, a DSP instead of the IU and/or transmit processor may initiate loading the plurality of buffers with the data at the second instance of time

In certain aspects, the operations 600 include loading the data into a local memory of the baseband processor, wherein loading the plurality of buffers with the portion of the wireless data comprises transferring the portion of the wireless data from the local memory to the plurality of buffers.

In certain aspects, the wireless data is associated with an ultra-low latency communication.

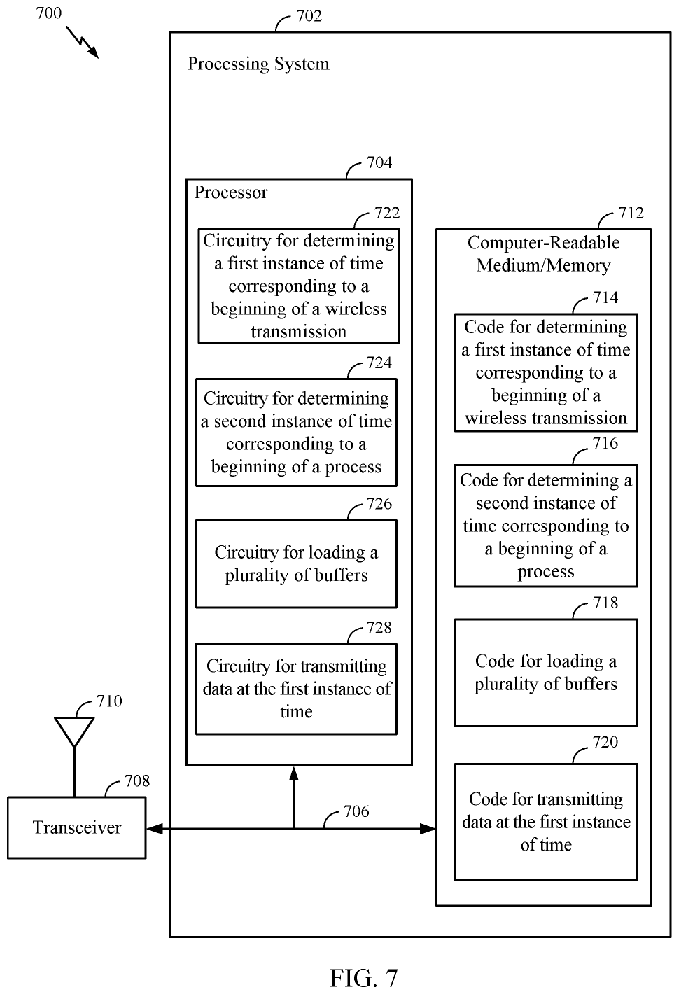

FIG. 7 illustrates a communications device 700 that may include various components (e.g., corresponding to means-plus-function components) configured to perform operations for the techniques disclosed herein, such as the operations illustrated in FIG. 6. The communications device 700 includes a processing system 702 coupled to a transceiver 708. The transceiver 708 is configured to transmit and receive signals for the communications device 700 via an antenna 710, such as the various signals as described herein. The processing system 702 may be configured to perform processing functions for the communications device 700, including processing signals received and/or to be transmitted by the communications device 700.

The processing system 702 includes a processor 704 coupled to a computer-readable medium/memory 712 via a bus 706. In certain aspects, the computer-readable medium/memory 712 is configured to store instructions (e.g., computer-executable code) that when executed by the processor 704, cause the processor 704 to perform the operations illustrated in FIG. 6, or other operations for performing the various techniques discussed herein for pre-loading buffers with data to align data readiness with transmission timing. In certain aspects, computer-readable medium/memory 712 stores code for determining a first instance of time corresponding to a beginning of a wireless transmission 714; code for determining a second instance of time corresponding to a beginning of a process 716; code for loading a plurality of buffers 718; and code for transmitting data at the first instance of time 720. In some examples, the computer-readable medium/memory 712 includes the control logic of a state machine which is operable to load the local memory with wireless data that will be transmitted during the time resources allocated for its transmission, and/or initiate loading the plurality of buffers with the data at the second instance of time.

In certain aspects, the processor 704 has circuitry (e.g., a hardware, control logic implementation) configured to implement the code stored in the computer-readable medium/memory 712. The processor 704 includes circuitry for determining a first instance of time corresponding to a beginning of a wireless transmission 722; circuitry for determining a second instance of time corresponding to a beginning of a process 724; circuitry for loading a plurality of buffers 726; and circuitry for transmitting data at the first instance of time 728. In some examples, the circuitry configured to implement the code stored in the computer-readable medium/memory 712 is implemented on a DSP.

FIG. 8 illustrates example components 800 of BS 110a and UE 120a (e.g., in the wireless communication network 100 of FIG. 1), which may be used to implement aspects of the present disclosure. Moreover, example components 800 of BS 110a and UE 120a may correspond to the example hardware components illustrated in FIG. 4. For example, transmit processors 820/864 of FIG. 8 may correspond to the transmit processor 408 of FIG. 4. In another example, modulators 832/854 and antennas 834/852 of FIG. 8 may correspond to the modulator/demodulator 402 and antennas 424 of FIG. 4, respectively. In another example, the controller/processors 840/880 of FIG. 8 may correspond to one or more of the baseband processor 402 or the DSP 418 of FIG. 4. In another example, the memory 842/882 of FIG. 8 may correspond to the local memory 410 of FIG. 4.

At the BS 110a, a transmit processor 820 may receive data from a data source 812 and control information from a controller/processor 840. The control information may be for the physical broadcast channel (PBCH), physical control format indicator channel (PCFICH), physical hybrid ARQ indicator channel (PHICH), PDCCH, group common PDCCH (GC PDCCH), etc. The data may be for the PDSCH, etc. The processor 820 may process (e.g., encode and symbol map) the data and control information to obtain data symbols and control symbols, respectively. The transmit processor 820 may also generate reference symbols, such as for the primary synchronization signal (PSS), secondary synchronization signal (SSS), and cell-specific reference signal (CRS). A transmit (TX) multiple-input multiple-output (MIMO) processor 830 may perform spatial processing (e.g., precoding) on the data symbols, the control symbols, and/or the reference symbols, if applicable, and may provide output symbol streams to the modulators (MODs) 832a-832t. Each modulator 832 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 832a-832t may be transmitted via the antennas 834a-834t, respectively.

At the UE 120a, the antennas 852a-852r may receive the downlink signals from the BS 110a and may provide received signals to the demodulators (DEMODs) in transceivers 854a-854r, respectively. Each demodulator 854 may condition (e.g., filter, amplify, downconvert, and digitize) a respective received signal to obtain input samples. Each demodulator may further process the input samples (e.g., for OFDM, etc.) to obtain received symbols. A MIMO detector 856 may obtain received symbols from all the demodulators 854a-854r, perform MIMO detection on the received symbols if applicable, and provide detected symbols. A receive processor 858 may process (e.g., demodulate, deinterleave, and decode) the detected symbols, provide decoded data for the UE 120a to a data sink 860, and provide decoded control information to a controller/processor 880.

On the uplink, at UE 120a, a transmit processor 864 may receive and process data (e.g., for the physical uplink shared channel (PUSCH)) from a data source 862 and control information (e.g., for the physical uplink control channel (PUCCH) from the controller/processor 880. The transmit processor 864 may also generate reference symbols for a reference signal (e.g., for the sounding reference signal (SRS)). The symbols from the transmit processor 864 may be precoded by a TX MIMO processor 866 if applicable, further processed by the demodulators in transceivers 854a-854r (e.g., for SC-FDM, etc.), and transmitted to the BS 110a. At the BS 110a, the uplink signals from the UE 120a may be received by the antennas 834, processed by the modulators 832, detected by a MIMO detector 836 if applicable, and further processed by a receive processor 838 to obtain decoded data and control information sent by the UE 120a. The receive processor 838 may provide the decoded data to a data sink 839 and the decoded control information to the controller/processor 840.

The memories 842 and 882 may store data and program codes for BS 110a and UE 120a, respectively. A scheduler 844 may schedule UEs for data transmission on the downlink and/or uplink. The controller/processor 880 and/or other processors and modules at the UE 120a may perform or direct the execution of processes for the techniques described herein.

For example, according to certain aspects, the BSs 110 and UEs 120 may be configured for preparing data for rapid availability for transmission to a UE 120a or a relay station 110r. As shown in FIG. 8, the controller/processor 840 of the BS 110a includes a timing control module 888. The timing control module 888 may be configured to determine a first instance of time corresponding to a beginning of a wireless transmission of data by a transceiver. The timing control module 888 may also determine a second instance of time corresponding to a beginning of a process configured to load a plurality of buffers with a portion of the data, wherein the second instance of time is determined as a function of an amount of time required to complete the process and the first instance of time. The timing control module 888 may also load the plurality of buffers with the data, wherein the loading is initiated at the second instance of time. The timing control module 888 may also transmit the data at the first instance of time. In certain aspects, the determining of the first instance of time and the second instance of time is performed by a baseband processor of the BS 110a. In certain aspects, the loading and transmitting are performed by a transceiver of the BS 110a.

As shown in FIG. 8, the controller/processor 880 UE 120a includes a timing control module 890 similar to the timing control module 888 of BS 110a. In the case of the UE 120a, the timing control module 890 may be configured for preparing data for rapid availability for transmission in a sidelink transmission to another UE (e.g., UE 120b) or in a transmission to a BS 110a.

Although shown at the controller/processor 840/880, other components of the UE 120a and BS 110a may be used performing the operations described herein.

### Additional Considerations

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 6.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method of wireless communication, comprising:
determining, by a baseband processor, a first instance of time corresponding to a beginning of a wireless transmission of data by a transceiver, wherein the baseband processor is coupled to the transceiver via a physical connection;
determining, by the baseband processor, a second instance of time corresponding to a beginning of a process configured to load a plurality of buffers with a portion of the data, wherein the second instance of time is determined as a function of an amount of time required to complete the process and the first instance of time;
loading, by the transceiver, of the plurality of buffers with the data, wherein the transceiver initiates the loading at the second instance of time; and
transmitting, by the transceiver, the data at the first instance of time.

2. The method of claim 1, wherein the second instance of time is determined such that the process is completed prior to the first instance of time.

3. The method of claim 1, wherein the physical connection is a digital radio frequency (RF) connection.

4. The method of claim 1, wherein the plurality of buffers include at least a first register at a digital RF connection master of the baseband processor, a second register at an RF connection slave of the transceiver, and a third register at a digital signal processor (DSP) of the transceiver.

5. The method of claim 1, wherein the transceiver is a slave to the baseband processor, and wherein the baseband processor comprises a control processor configured to perform the determining of the first instance of time and the second instance of time.

6. The method of claim 5, further comprising:
wirelessly receiving, by the transceiver, information indicative of a time resource allocation for transmitting the data;
communicating the information indicative of the time resource allocation to the control processor; and
determining, by the control processor, the first instance of time based on the time resource allocation.

7. The method of claim 5, further comprising retrieving, by the control processor, the amount of time required to complete the process from a memory.

8. The method of claim 1, further comprising signaling, by the baseband processor, the second instance of time to the transceiver.

9. The method of claim 8, wherein signaling the second instance of time to the transceiver comprises:
signaling, by the baseband processor, the second instance of time to a digital signal processor (DSP) of the transceiver; and
signaling, by the DSP, the second instance of time to one of an integer unit of the transceiver or a control logic of the transceiver, wherein the integer unit or the control logic initiates loading the plurality of buffers with the data at the second instance of time.

10. The method of claim 1, further comprising loading the data into a local memory of the baseband processor, wherein loading the plurality of buffers with the portion of the data comprises transferring the portion of the data from the local memory to the plurality of buffers.

11. The method of claim 1, wherein the data is associated with an ultra-low latency communication.

12. An apparatus configured for wireless communication, comprising:
a memory; and
a baseband processor communicatively coupled to the memory, wherein the baseband processor is configured to:
determine a first instance of time corresponding to a beginning of a wireless transmission of data;
determine a second instance of time corresponding to a beginning of a process configured to load a plurality of buffers with a portion of the data, wherein the second instance of time is determined as a function of an amount of time required to complete the process and the first instance of time; and
a transceiver communicatively coupled to the baseband processor via a physical connection, wherein the transceiver is configured to:
load the plurality of buffers with the data, wherein the transceiver initiates the loading at the second instance of time; and
transmit the data at the first instance of time.

13. The apparatus of claim 12, wherein the second instance of time is determined such that the process is completed prior to the first instance of time.

14. The apparatus of claim 12, wherein the physical connection is a digital radio frequency (RF) connection.

15. The apparatus of claim 12, wherein the plurality of buffers include at least a first register at a digital RF connection master of the baseband processor, a second register at an RF connection slave of the transceiver, and a third register at a digital signal processor (DSP) of the transceiver.

16. The apparatus of claim 12, wherein the transceiver is a slave to the baseband processor, and wherein the baseband processor comprises a control processor configured to perform the determining of the first instance of time and the second instance of time.

17. The apparatus of claim 16, further comprising:
wirelessly receiving, by the transceiver, information indicative of a time resource allocation for transmitting the data;
communicating the information indicative of the time resource allocation to the control processor; and
determining, by the control processor, the first instance of time based on the time resource allocation.

18. The apparatus of claim 16, further comprising retrieving, by the control processor, the amount of time required to complete the process from a memory.

19. The apparatus of claim 12, further comprising loading the data into a local memory of the baseband processor, wherein loading the plurality of buffers with the portion of the data comprises transferring the portion of the data from the local memory to the plurality of buffers.

20. A non-transitory computer readable medium having instructions stored thereon for:
determining, by a baseband processor, a first instance of time corresponding to a beginning of a wireless transmission of data by a transceiver, wherein the baseband processor is coupled to the transceiver via a physical connection;
determining, by the baseband processor, a second instance of time corresponding to a beginning of a process configured to load a plurality of buffers with a portion of the data, wherein the second instance of time is determined as a function of an amount of time required to complete the process and the first instance of time;
loading, by the transceiver, of the plurality of buffers with the data, wherein the transceiver initiates the loading at the second instance of time; and
transmitting, by the transceiver, the data at the first instance of time.
